(19) United States
(12) Patent Application Publication
(10) Pub. No.: US 2012/0132764 A1
(43) Pub. Date: May 31, 2012

(54) APPARATUS FOR SECURING A DEVICE IN A VIEWABLE LOCATION

(76) Inventors: Roger Ball, Little Rock, AR (US); Paul Freudenberg, Memphis, TN (US)

(21) Appl. No.: 13/294,489

(22) Filed: Nov. 11, 2011

Related U.S. Application Data
(63) Continuation of application No. PCT/US2010/034565, filed on May 12, 2010.
(60) Provisional application No. 61/177,945, filed on May 13, 2009.

(51) Int. Cl. F16M 11/00; F16M 11/32; F16M 11/14; F16M 11/06

(52) U.S. Cl. 248/125.1; 248/122.1

(57) ABSTRACT

An apparatus for securing a device in a viewable location which obviates the need to hold viewable devices in a viewer's hand comprising a clamp 1, the claim further comprising an upper clamp portion 3 interference fit to a lower clamp portion 5 and a ball 7 associated with the clamp which is associated with a socket 9, which in turn is associated with a downwardly extending leg 11. The apparatus further comprises a downwardly extending leg 11 such that the height of the downwardly extending leg 11 is controlled by its position within an elevation member 13. The downwardly extending leg 11 is held in place with a removable friction ring 15 placed around the downwardly extending leg 11 and holding the downwardly extending leg 11 in place within the elevation member 13. Two or more legs 17 are coupled to the elevation member 13 by hinged joints 19.

### CROSS REFERENCE TO RELATED APPLICATION

This application is a continuation of w, filed May 12, 2010, which claims priority to U.S. Provisional Application 61/177,945, filed May 13, 2009.

### FIELD OF THE INVENTION

The present invention relates to an apparatus for securing a device in a viewable location, which obviates the need to hold viewable devices in a viewer's hand.

### BACKGROUND

With the advent and popularity of portable video players (e.g. iPods® and similar players) there arises a need for an apparatus that can hold such a device for hands-free viewing of the device, such as when a user is traveling in an airplane. This invention addresses the problem of viewing a portable media device without requiring the device to be held in a viewer's hand. This invention thus allows viewing or listening to portable media while the viewer's hands are free.

### SUMMARY OF THE INVENTION

It is a general object of the present invention to provide an apparatus for securing a device, such as a portable video player, in a viewable location. This and other objects of the invention are achieved by providing such an apparatus comprising a clamp configured to removably secure the device to the apparatus. The clamp engages at least two opposed edges of the device. At least one leg extends downwardly from the clamp and is configured to rest on a surface and to locate the clamp and device relative to the surface for viewing the device. A flexible joint is formed between the clamp and leg to permit selective orientation of the clamp and device relative to the legs.

According to a preferred embodiment of the present invention, the leg further comprises three legs secured together at their upper ends to form a collapsible tripod.

According to a preferred embodiment of the present invention, the flexible joint further comprises a ball associated with the clamp and a socket associated with the leg and configured to receive the ball.

According to a preferred embodiment of the present invention, an elevation member is coupled between the flexible joint and the legs and is movable relative to the legs, wherein a distance between the surface and the device can be selected.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1-4 are elevation views of the apparatus or stand according to the present invention;

FIG. 5 is an enlarged side elevation view of the clamp assembly of the stand of FIGS. 1-4;

FIG. 6 is a plane view of the hinge member of the apparatus of FIGS. 1-4.

### DETAILED DESCRIPTION OF THE INVENTION

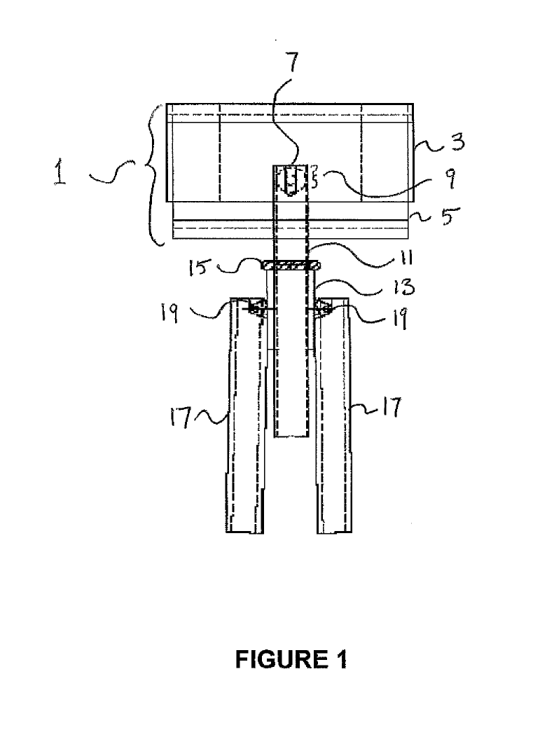

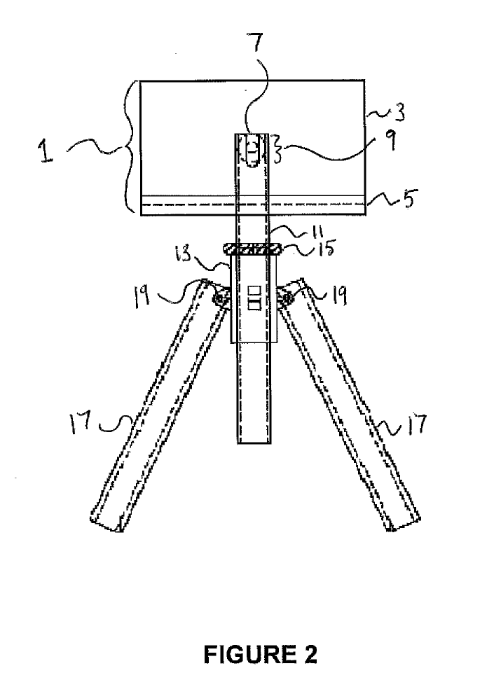

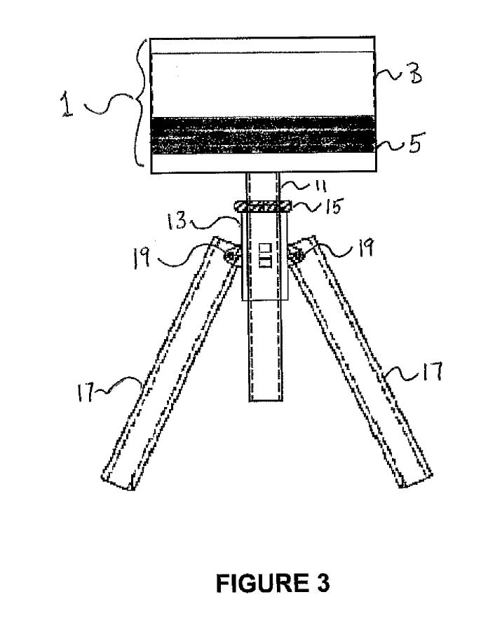

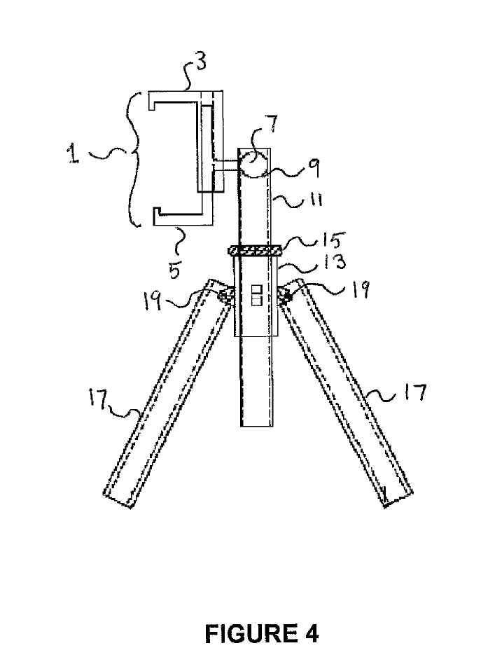

Referring now to the Figures, with particular reference to FIGS. 1-6, the apparatus according to the present invention is illustrated.

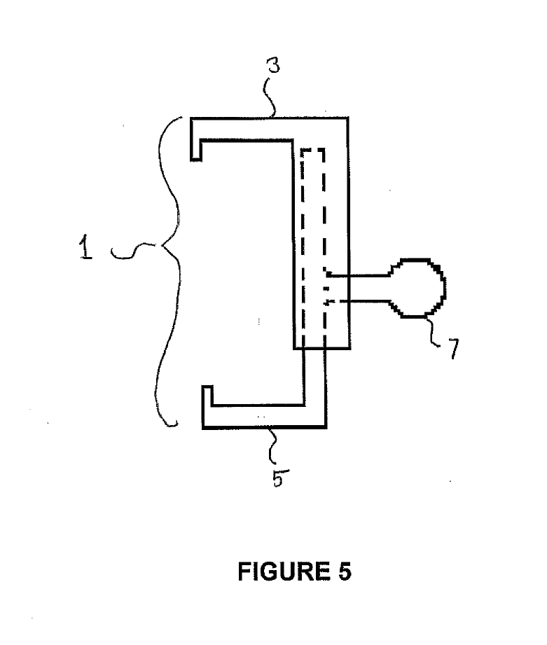

FIGS. 1-4 illustrate the clamp and stand of the apparatus of the present invention, which generally comprises a clamp for securing a portable media device to a stand for locating the device in a renewable location. Clamp 1 comprises an upper clamp portion 3 that is interference sliding fit to a lower clamp portion 5. The interference sliding fit allows the clamp width to be adjusted by a viewer to accommodate a variety of media devices (shown in phantom in FIG. 5) varying in size and shape.

A ball 7 is associated with the clamp and is received in a socket 9. The ball 7 and socket 9 connect clamp 1 to tubular elevation member 11 in a flexible joint or connection. Ball 7 is moveably interference fit in the upper end of tube 11, which defines socket 9. This allows for adjustment of clamp orientation with respect to the viewer.

Elevation member 11 is slidably received in a tubular hinge member 13. Movement of elevation member 11 relative to hinge member 13 is controlled by a resilient, elastomer o-ring 15 that encircles the elevation member 11 and provides a stop against further downward movement of elevation member 11 relative to hinge member 13. This arrangement allows the height of the clamp to be adjusted by the viewer for optimal viewing of a media device.

At least one and preferably three tubular legs 17 are secured in a tripod arrangement to hinge member 13 by three hinges spaced around the circumference of hinge member 13. Legs 17 thus are foldable or collapsible relative to the remainder of the stand or apparatus.

FIG. 5 illustrates the clamp in greater detail. Clamp 1 has an upper clamp portion 3, a lower clamp portion 5, and a ball 7 secured to one of portions 3, 5. Upper clamp portion 3 and lower clamp portion 5 fit into one another in a slidable interference fit configuration which allows for adjustment of the clamp for the accommodation of devices of varying size. The ball is sized for interference fit into a socket formed by elevation member 11 as described above. The sliding clamp portions can be adjusted to accept devices of varying shape and size. The orientation of the device may then be adjusted by the ball and socket connector to optimize viewing angle.

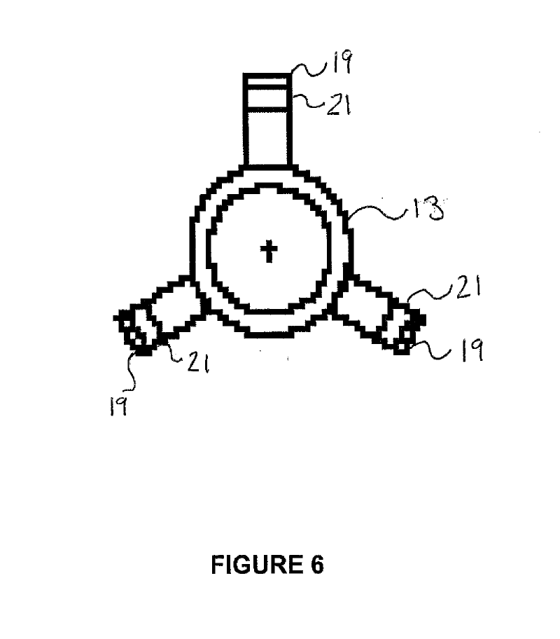

FIG. 6 illustrates the tubular hinge member 13 and hinges 19. As shown, the hinges 19 of the elevation member 13 are formed by hinge apertures 21. A pin 23 or other connecting piece extends through apertures in the upper portion of the legs 17 and the hinge aperture 21 to secure the legs to the hinge member 13. The three legs extend downward from the hinge member 13 and hinges 19 in a tripod arrangement such that the legs provide stable support for the apparatus upon a viewing surface when deployed. The legs may also be collapsed for storage of the apparatus.

As described above, the apparatus or stand according to the present invention can be stored with legs 17 collapsed in luggage or other relatively small spaces. The legs 17 can be deployed and placed on a surface, the portable device engaged in clamp 1, and the clamp oriented in a satisfactory manner for viewing. The relative height of clamp 1 can be adjusted by use of elevation member 11 and o-ring 15.

The apparatus has a number of advantages. It is adapted to be inexpensively constructed primarily of tubing comprised of a plastic, such as acrylonitrile butadiene styrene (ABS). Such plastic or non-metallic construction makes the stand according to the present invention particularly suited to travel because it will not set off metal detectors at security checkpoints.

What is claimed is:

1. An apparatus for securing a device in a viewable location, the apparatus comprising:
a clamp configured to removably secure the device to the apparatus, the clamp engaging at least two opposed edges of the device;
at least one leg extending downwardly from the clamp, the leg configured to rest on a surface and to locate the clamp and device relative to that surface for viewing the device; and
a flexible joint between the clamp and leg to permit selective orientation of the clamp and device relative to the leg.

2. The apparatus of claim 1, wherein the leg further comprises:
three legs secured together at their upper ends to form a collapsible tripod.

3. The apparatus of claim 1, wherein the flexible joint further comprises:
a ball associated with the clamp; and
a socket associated with the leg and configured to receive the ball.

4. The apparatus of claim 1, further comprising:
an elevation member coupled between the flexible joint and the leg, the elevation member being movable relative to the leg, wherein a distance between the surface and the device can be selected.

5. The apparatus of claim 2, wherein each of the three legs is secured by a hinge to an exterior of a tubular leg member.

6. The apparatus of claim 5, wherein a tubular elevation member is slidably received in the tubular leg member and a resilient member is carried on an exterior of the elevation member to secure the elevation member relative to the leg member.

7. The apparatus of claim 6, wherein the flexible joint further comprises:
a ball associated with the clamp, the ball received in an upper end of the elevation member.
